(19) United States
(12) Patent Application Publication
(10) Pub. No.: US 2003/0188273 A1
(43) Pub. Date: Oct. 2, 2003

(54) Simulation-based technique for contention avoidance in automatic test pattern generation

(75) Inventors: Sandip Kundu, Austin, TX (US); Saniay Sengupta, San Jose, CA (US); Dhiraj Goswami, Mountain View, CA (US)

Correspondence Address: Schwegman, Lundberg, Woessner & Kluth, P.A., P.O. Box 2938, Minneapolis, MN, 55402, US

(73) Assignee: Intel Corporation

(21) Appl. No.: 10/109,089

(22) Filed: Mar. 28, 2002

(51) Int. Cl. G06F 17/50; G06F 9/45

(52) U.S. Cl. 716/4; 716/5

(57) ABSTRACT

A technique for finding contention-free states for contention-causing multiply driven nodes in an integrated circuit device to form a contention-free structural test pattern. The technique includes identifying multiply driven nodes having potential for causing contention by applying a predetermined number of random state assignments to the integrated circuit device. A scan group is identified using the identified contention-causing multiply driven nodes. Independent scan groups (ISGs) are created by identifying common elements in the identified scan groups and merging the identified scan groups to create ISGs. Contention-free states are found for each of the created scan groups.

### BACKGROUND

Embodiments of the invention generally relate to semiconductor integrated circuit devices, and more particularly to automatic test pattern generation for testing semiconductor devices.

Testing an integrated circuit device or a packaged component including circuitry (generally referred to as a device under test (DUT)) at the time it is manufactured and before it is incorporated into a next level assembly is generally necessary to ascertain the functionality of the DUT. A microprocessor, for instance, should be tested before it is incorporated into a next level assembly to avoid the cost of discarding the whole assembly, or to avoid a costly diagnosis and repair after it is assembled into the next level assembly.

Traditionally, microprocessors and integrated circuit devices have been subjected to functional testing using an external tester. These external testers contain a large memory that stores test data patterns of ones and zeros used as inputs to the microprocessor, along with patterns of correct outputs expected from the microprocessor. The benefits of functional testing include testing the device in the native mode of operation, making speed testing easier, and providing collateral coverage of faults not modeled during the fault grading process. The drawback of functional testing is that the external tester performance has to keep up with microprocessor performance improvements, and the writing of test data patterns for functional testing can take a lot of man-years. Also, functional testing generally increases tester data volume and the application time require to develop the test methodology.

To circumvent the problem of increased tester data volume and application time, a special test mode is designed into the microprocessor circuitry. When this mode of operation is selected, the internal state of nodes in the microprocessor circuitry can be accessed, initialized and controlled directly from the tester without having to run through the functional inputs and outputs that are used in normal operation mode. Using this type of test mode to test the microprocessor accomplishes the testing of the structure of the microprocessor, and not the whole function of the microprocessor. Testing the microprocessor using the special test mode is generally known as “structural testing”. Structural testing can considerably reduce test data volume and application time, and permits using automatic tools to program the tester, which in turn reduces the time required to write test data patterns. However, structural testing targets fault models and not functionality, and are generally small in number. Typically, structural testing targets thousands of vectors as opposed to millions of vectors targeted in a functional test.

To overcome this limitation, techniques such as Built-In Self-Test (BIST) have been proposed, which apply a large volume of structural testing to the device. BIST uses random data patterns to test the DUT in the test mode. When using random data patterns in the test mode, the state elements are configured in a long daisy chain, such that the test data moves serially from one state element to another, eventually coming out of an external pin in the DUT. The term “state elements” in this document refers to parts of the microprocessor circuit that potentially hold data for at least one clock cycle. The use of these random data patterns considerably reduces the volume of stored bits on a tester, thereby significantly simplifying and reducing the cost of testing the DUTs.

BIST can compress the test results into a single smaller pattern or “signature”, to reduce the amount of tester memory and circuitry required. The signature is then analyzed to determine whether the DUT is free of structural defects. The random pattern generator and the signature analyzer circuitry can be built into the DUT itself. This eliminates the need for using an external tester to test the DUT.

To apply random data patterns, 0's and 1's are used to energize various parts of circuitry in the DUT. In some cases, however, the application of random data patterns can set up electrically undesirable configurations (undesirable bit segments). For example, applying a non-functional scan test can cause drive fights among multiple drivers sharing a common bus. This configuration, also known as “multiply driven nodes (MDNs) or bus contentions,” can result in electrical short circuit from the power supply to ground and can potentially cause burnout or reliability issues in the DUT. A multiply driven node (MDN) is an electrical net that has more than one gate driving it. When a driver is turned on (i.e., not tri-stated), it creates an electrically conducting path from a supply rail to the MDN. Examples of MDNs include busses, pass-transistor multiplexors and multi-ported latches, memory arrays and so on. If multiple drivers are turned on simultaneously, a conducting path may set up between supply rails at different voltages. Such a state is generally referred to as a contention state. Such configurations are generally ruled out by design in the functional mode. In the functional mode this is accomplished by using a mutually exclusive logic that enables the driver. This means that the local logic that enables the driver to drive a node guarantees that only one driver can be on at a certain time. But it is extremely difficult and expensive to use such mutually exclusive logic and guarantee that contention states will not arise during structural testing when applying application of random data patterns.

Current approaches to avoid the possibility of contention require either designing the device to avoid any possibility of contention during structural tests, or creating structural test patterns that are contention-free by construction. The first approach requires automated scan design rule checking and very strict adherence to scan design rules. Typically, adhering to scan design rules can have a significant impact on area, performance, and design productivity of the integrated circuit device. The second approach can only be used when the number of contention sites is small, generally less than 100. When the number of contention sites is high, test generation tools run into capacity and performance limitations, resulting in high throughput times and poor fault coverage. Generally, these approaches cannot be used for randomly generated tests such as those produced in BIST.

### BRIEF DESCRIPTION OF THE DRAWINGS

FIG. 1 is a flow diagram of one embodiment of the present subject matter.

FIG. 2 is a schematic illustrating an embodiment of identifying and merging scan groups according to the present subject matter.

FIG. 3 shows an embodiment of a suitable computing system environment for implementing the present subject matter.

### DETAILED DESCRIPTION

In the following detailed description of the embodiments, reference is made to the accompanying drawings that show, by way of illustration, specific embodiments in which the subject matter may be practiced. In the drawings, like numerals describe substantially similar components throughout the several views. These embodiments are described in sufficient detail to enable those skilled in the art to practice the subject matter. Other embodiments may be utilized and structural, logical, and electrical changes may be made without departing from the scope of the present subject matter. Moreover, it is to be understood that the various embodiments of the subject matter, although different, are not necessarily mutually exclusive. For example, a particular feature, structure, or characteristic described in one embodiment may be included within other embodiments. The following detailed description is, therefore, not to be taken in a limiting sense, and the scope of the present subject matter is defined only by the appended claims, along with the full scope of equivalents to which such claims are entitled.

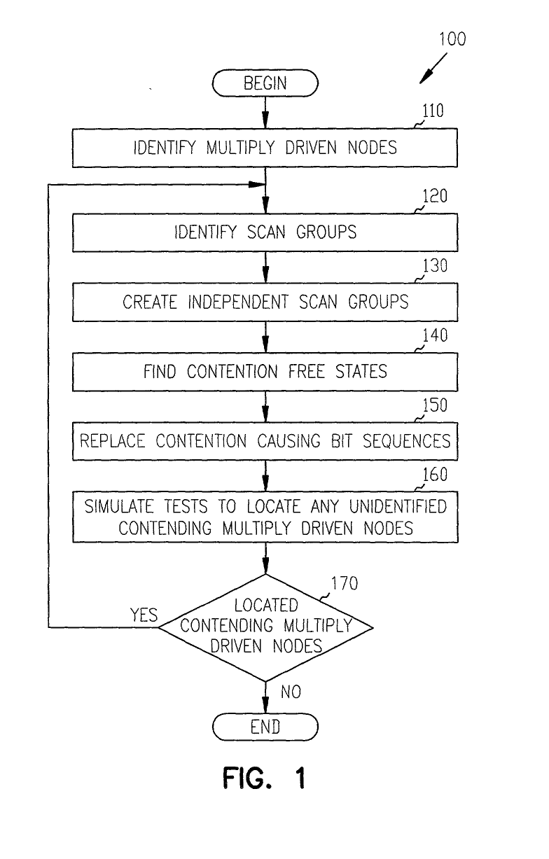

FIG. 1 is an flow chart 100 of an exemplary method for finding contention-free states for multiply driven nodes having the potential for causing contention in an integrated circuit. In addition, flow chart 100 illustrates a method for forming a contention-free structural test pattern for structurally testing an integrated circuit device, also referred to as a device under test (DUT). In some embodiments, the integrated circuit device can include a microprocessor.

Flow chart 100 includes blocks 110-170, which are arranged serially in the exemplary embodiment. However, other embodiments may execute two or more blocks in parallel, using multiple processors or a single processor organized as two or more virtual machines or subprocessors. Moreover, still other embodiments implement the blocks as two or more specific interconnected hardware modules with related control and data signals communicated between and through the modules, or as portions of an application-specific integrated circuit. Thus, the exemplary process flow is applicable to software, firmware, and hardware implementations.

Block 110 identifies multiply driven nodes having the potential for causing contention by applying a predetermined number of random state assignments to the integrated circuit device. In some embodiments, contention-causing multiply driven nodes are identified by applying a predetermined number of random state assignments to test the device. Further, the test is simulated and monitored using a logic simulator. During the simulation the test is monitored to identify multiply driven nodes reaching contention state. This is the initial list of identified multiply driven nodes having the potential to cause contention. In some embodiments, the predetermined number of random state assignments can be a larger number, such as a 1000 random state assignments. At this stage, most of the potentially contending multiply driven nodes will be identified. In some embodiments, outcome of the applied structural test patterns is monitored during simulation using the logic simulator to locate multiply driven nodes having contention. In some embodiments, identified multiply driven nodes having contention are mapped to an associated scan group to identify bit sequences in the structural test pattern that can cause contention.

Block 120 identifies a scan group associated with each of the identified contention-causing multiply driven nodes. In some embodiments, the scan group is identified by performing a backward network traversal from each of the identified multiply driven nodes through combinational logic gates in an input cone, and stopping when a scan element is found. Input cone is a transitive fanin of a gate (i.e., predecessors of a gate, the predecessors of the predecessors, and so on until a scan element or a primary input is reached). In some embodiments, the backward network traversal is performed using algorithms such as a standard acyclic graph traversal algorithm, a depth-first search algorithm, and/or a breadth-first search algorithm. The identified combinationally reachable scan elements in the input cone are then grouped to form a scan group associated with each of the identified multiply driven nodes. A scan group is a set of scan elements that are reachable from a multiply driven node.

Block 130 creates independent scan groups (ISGs) by identifying common elements in the identified scan groups and further merging the identified scan groups to create the ISGs. In some embodiments, the ISGs are identified by locating overlapping elements in each of the formed scan groups. The overlapping elements are then merged using the located overlapping elements to create the ISGs.

Block 140 finds contention-free states for each of the created ISGs. In some embodiments, the contention-free states are determined by comparing the number of scan elements in the identified scan groups with a predetermined number of scan elements. When the number of scan elements in the ISGs is less than the predetermined number of scan elements, the contention-free states are found by applying and simulating all possible state assignments for the elements in the group. When the number of scan elements in the ISGs is greater than or equal to the predetermined number of scan elements, the contention-free states are found by applying and simulating the predetermined number of random state assignments for each of the created ISGs and further monitoring the simulation to find the contention-free states.

In some embodiments, applying and simulating the predetermined number of random state assignments further includes stopping the simulation when a predetermined number of contention-free states are identified. In some embodiments, heuristics are used to reduce the search time required to find contention-free states. In some embodiments, heuristics is based on using one-hot state assignment in which one of the elements in the scan group is set to logic ‘1’ and all of the other elements in the scan group is set to ‘0’. One-hot state assignment means exactly one of the bits is at logic ‘1’, and the rest of the bits are all at logic ‘0’. Using hueristics can be advantageous when scan elements are used to directly drive enable lines of tristate drivers on a bus, and exactly one of the drivers have to be active in order to prevent contention of the bus.

In some embodiments, when the number of scan elements in the identified independent scan group (ISG) is greater than the predetermined number of scan elements, the contention-free states are found by simulating a functional sequence on a logic model of the design. Then monitoring states of the identified state elements including an ISG. Then the identified state elements including combination of states are stored contention-free states. In some embodiments, contention causing bits found in block 110 is replaced with contention-free states found in block 140. As a result, the structural tests applied in subsequent blocks do not have any contention at the MDNs found in block 110. Any additional MDNs found in block 110 will be identified in block 160.

In some embodiments, the identified contention-free states are further generalized to reduce the number of specified bits in an assignment (i.e., bits that need to be at a logic ‘1’ or ‘0’). In addition, generalization is done to maximize the randomness of a final test, or to minimize the number of bits that is needed to be ‘fixed.’ Generalization is done by tuning a bit of an assignment from a ‘0’ or ‘1’ to an ‘X’, or to a do not care state, and then simulating the new state assignment and checking if there is contentions. If there is no contention, the bit is left unspecified, and if there is contention at the bus, then the bit is reverted back to its original value. This is done progressively for all of the bits in the assignment.

The identified contention-free states are fully specified, i.e., each state element in an independent scan group (ISG) is assigned with a binary value (0 or 1). Such a fully specified state may not be needed to avoid contention at all of the identified multiply driven nodes. In these embodiments, generalization is accomplished by replacing a first bit in the identified contention-free state with an unknown logic ‘X’, and re-simulating the replaced contention free state to verify whether all of the multiply driven nodes driven by the independent scan groups(ISGs) remain contention-free. The above actions are then repeated for the next subsequent bit in the identified contention-free state until all of the bit locations in the identified contention-free state have been verified to be necessary for the contention-free state.

Block 150 replaces the identified contention-causing bit sequences with the associated found contention-free states to form the contention-free structural test pattern for testing the integrated circuit device. In some embodiments, when more than one contention-free state is found for a given ISG, block 150 replaces the contention-causing bit sequence with any one of those found states. The selection of contention-free states can be changed to improve the effectiveness of the test patterns. For example, when replacing the identified contention-causing bit sequences different contention-free states may be selected at random, or a new contention-free state may be selected at random, or a new contention-free state may be selected in round-robin fashion after replacing a fixed number of test patterns.

Block 160 simulates the formed contention-free structural test patterns by applying the formed contention-free structural test patterns and monitoring the outcome of the applied tests using a logic simulator to further locate any unidentified multiply driven nodes. In some embodiments, block 160 applies replaced structural test patterns to find contention-causing bit sequences in a scan chain in an integrated circuit device. In these embodiments, this is accomplished by simulating structural tests. The structural tests are simulated by applying structural test patterns to a scan chain in the integrated circuit device using a logic simulator.

Block 170 repeats the blocks 120-170 based on the outcome of the monitoring. In these embodiments, the formed contention-free structural test pattern is outputted without repeating the above actions when there are no additional multiply driven nodes located, and further repeating the above actions when additional multiply drive nodes are located. In general, blocks 120-170 may have to be repeated at most once to identify all the nodes that can contend during the application of the structural test pattern.

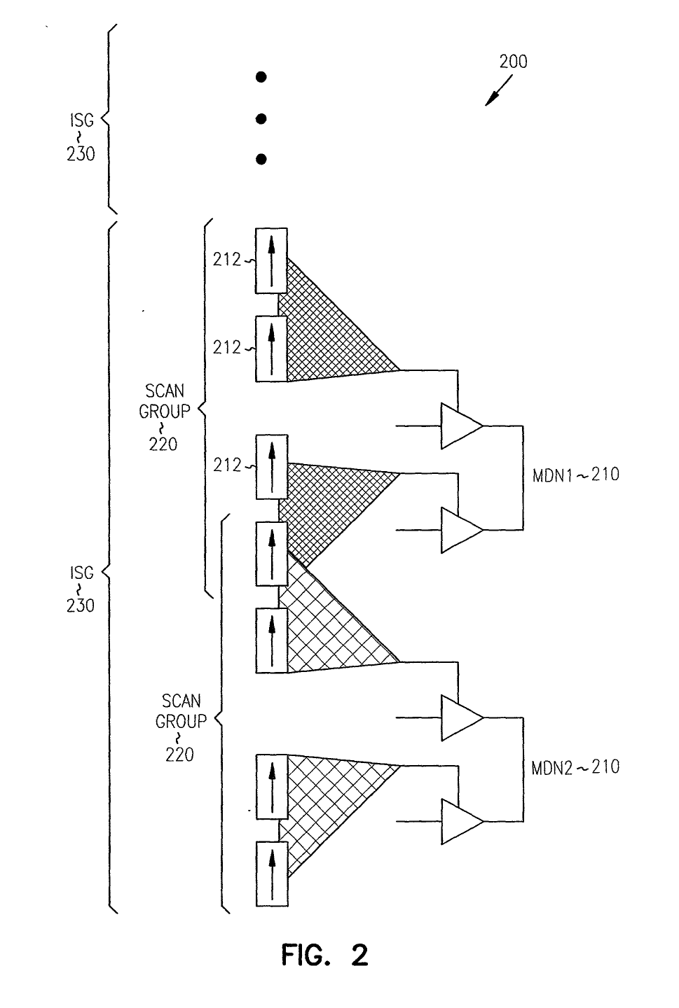

FIG. 2 is a schematic 200 illustrating one example embodiment of identifying and merging scan groups for the present subject matter. As shown in FIG. 2, the contention-causing multiply driven nodes 210 are first identified by simulating and applying structural test patterns to the elements in a scan chain 212 of an integrated circuit. Scan groups 220 associated with each of the identified contention-causing multiply driven nodes 210 are then identified. Independent scan groups 230 (ISGs) are then created by identifying common elements in the ISGs and by further merging the ISGs 220 to create the ISGs 230.

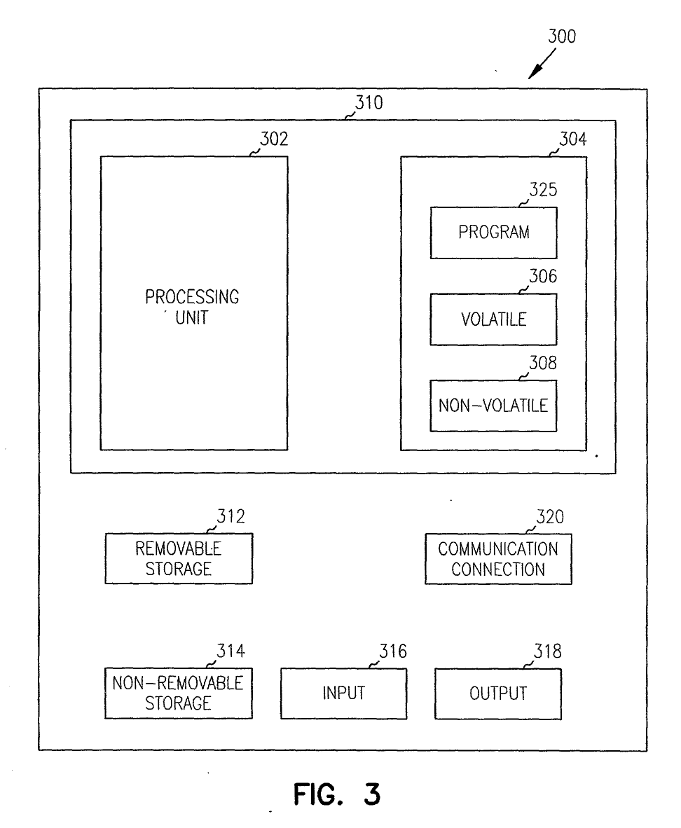

Various aspects of the present subject matter shown in FIGS. 1 and 2 can be implemented in software, which may be run in the environment shown in FIG. 3 or in any other suitable computing environment. The present subject matter is operable in a number of other general purpose or special purpose computing environments. Some computing environments are personal computers, general-purpose computers, server computers, hand held devices, laptop devices, multiprocessors, microprocessors, set top boxes, programmable consumer electronics, network PCs, minicomputers, mainframe computers, distributed computing environments and the like to execute code stored on a computer readable medium. The present subject matter may be implemented in part or in whole as computer-executable instructions, such as program modules that are executed by a computer. Generally, program modules include routines, programs, objects, components, data structures and the like to perform particular tasks or to implement particular abstract data types. In a distributed computing environment, program modules may be located in local or remote storage devices.

FIG. 3 shows a general computing device in the form of a computer 310, which may include a processing unit 302, memory 304, removable storage 312, and non-removable storage 314. The memory 304 may include volatile memory 306 and non-volatile memory 308. Computer 310 may include—or have access to a computing environment that includes—a variety of computer-readable media, such as volatile memory 306 and non-volatile memory 308, removable storage 312 and non-removable storage 314. Computer storage includes RAM, ROM, EPROM & EEPROM, flash memory or other memory technologies, CD ROM, Digital Versatile Disks (DVD) or other optical disk storage, magnetic cassettes, magnetic tape, magnetic disk storage or other magnetic storage devices, or any other medium capable of storing computer-readable instructions. Computer 310 may include or have access to a computing environment that includes input 316, output 318, and a communication connection 320. The computer may operate in a networked environment using a communication connection to connect to one or more remote computers. The remote computer may include a personal computer, server, router, network PC, a peer device or other common network node, or the like. The computer can also include hand held devices, such as phones and PDAs. The communication connection may include a Local Area Network (LAN), a Wide Area Network (WAN) or other networks.

Computer-readable instructions stored on a computer-readable medium are executable by the processing unit 302 of the computer 310. A hard-drive, CD ROM, and RAM are some of the above-mentioned examples of articles including a computer-readable medium. For example, a computer program 325 capable of finding the contention-free states in an integrated circuit device according to the teachings of the present invention.

The above-described methods and apparatus provides, among other things, a technique to generate contention-free structural test patterns for structural testing of integrated circuit devices that do not rely on design changes which can increase the die size, design effort, and overhead.

It is to be understood that the above description is intended to be illustrative, and not restrictive. Many other embodiments will be apparent to those of skill in the art upon reviewing the above description. The scope of the subject matter should, therefore, be determined with reference to the following claims, along with the full scope of equivalents to which such claims are entitled.

What is claimed is:

1. A method of finding contention-free states in an integrated circuit device, comprising:
identifying multiply driven nodes having potential for causing contention by applying a predetermined number of random state assignments to the integrated circuit device;
identifying a scan group associated with each of the identified contention-causing multiply driven nodes;
creating independent scan groups by identifying common elements in the identified scan groups and merging the identified scan groups to create independent scan groups; and
finding contention-free states for each of the created independent scan groups.

2. The method of claim 1, further comprising:
simulating structural tests by applying structural test patten to a scan chain in the integrated circuit using a logic simulator;
monitoring an outcome of the applied structural test patterns using the logic simulator during simulation to locate multiply driven nodes having contention;
mapping the located multiply driven nodes having contention to an associated scan group to identify bit sequences in the structural test pattern that can cause contention; and
replacing the identified contention-causing bit sequences with the associated found contention-free states to form the contention-free structural test pattern.

3. The method of claim 2, further comprising:
simulating structural tests by applying the formed contention-free structural test patterns to the scan chain;
monitoring the outcome of the simulated tests using the logic simulator to locate any further unidentified contending multiply driven nodes in the scan chain;
if the logic simulator cannot further locate any contending multiply driven nodes, then outputting the contention-free structural test pattern for testing the integrated circuit device for structural defects; and
if the logic simulator does locate contending multiply driven nodes, then repeating the above actions to replace the contention-causing bit sequences with contention-free states to form the contention-free structural test pattern.

4. The method of claim 1, wherein identifying multiply driven nodes having potential for contention further comprises:
applying the predetermined number of random state assignments to test the device;
simulating and monitoring the test using a logic simulator;
monitoring during simulation to identify multiply driven nodes reaching contention state; and
identifying the multiply driven nodes having potential for contention based on the outcome of the monitoring.

5. The method of claim 4, wherein identifying the scan group associated with each of the identified contention-causing multiply driven nodes further comprises:
performing a backward network traversal from each of the identified multiply driven nodes through combinational logic gates in an input cone and stopping when a scan element is found; and
grouping all of the scan elements driving the combinational input cone of the identified multiply driven nodes to form the scan group associated with each of the identified multiply driven nodes.

6. The method of claim 5, wherein backward network traversal can be performed using algorithms selected from the group consisting of a standard acyclic graph traversal algorithm, a depth-first search algorithm, and a breadth-first search algorithm.

7. The method of claim 5, wherein creating independent scan groups further comprises:
identifying overlapping elements in each of the formed scan groups; and
merging the scan groups having overlapping elements using the identified overlapping elements to create the independent scan groups.

8. The method of claim 7, wherein finding the contention-free states for each of the created independent scan groups further comprises:
if the number of scan elements in the identified independent scan groups is less than a predetermined number of scan elements, then applying and simulating all possible state assignments for the elements in the group, and further finding the contention-free states that do not result in contention at any of the multiply driven nodes driven by the independent scan groups; and
if the number of scan elements in the independent scan groups is greater than or equal to the predetermined number of scan elements, then applying and simulating the predetermined number of random state assignments for the created independent scan groups,
monitoring the simulation and finding states that do not result in contention at any of the multiply driven nodes driven by each of the independent scan groups.

9. The method of claim 8, wherein applying and simulating the predetermined number of random state assignments further comprises:
stopping the simulation when a predetermined number of contention-free states are identified.

10. The method of claim 8, further comprising:
heuristically reducing search time required in finding states that do not result in contention.

11. The method of claim 10, wherein the heuristics is based on a one-hot state assignment in which one of the elements in the scan group is set to logic ‘1’, and all of the other elements in the scan group is set to ‘0’.

12. The method of claim 8, wherein finding the contention-free states for each of the created independent scan groups comprises:
if the number of scan elements is the identified independent scan groups is greater than the predetermined number of scan elements, then simulating a functional sequence on a logic model of the design, monitoring states of the state elements comprising an independent scan group, and storing the combination of states as contention-free states.

13. The method of claim 1, wherein replacing the located contention-causing multiply driven nodes in the random test pattern with the associated contention-free states further comprises:
replacing a first bit in the contention-free state with an unknown logic X;
re-simulating the replaced contention-free state to verify whether all of the multiply driven nodes driven by the independent scan groups remains contention-free;
randomly assigning the replaced first bit and leaving the first bit unspecified based on the outcome of the re-simulation; and
repeating the above actions for the next subsequent bits in the contention-free state until all of the bit locations in the contention-free state have been verified to be necessary in the contention-free state.

14. A method of generating a contention-free structural test pattern for an integrated circuit device, comprising:
identifying multiply driven nodes having the potential for causing contention by applying a predetermined number of random state assignments to the integrated circuit device;
identifying a scan group associated with each of the identified contention-causing multiply driven nodes;
creating independent scan groups by identifying common elements in the identified scan groups and merging the identified scan groups to create independent scan groups; and
finding contention-free states for each of the created independent scan groups;
applying structural test pattens to a scan chain in the integrated circuit using a logic simulator;
monitoring the outcome of the testing using the logic simulator to simulate and locate multiply driven nodes having contention;
mapping the located multiply driven nodes having contention to an associated scan group to identify bit sequences in the structural test pattern that can cause contention; and
replacing the located contention-causing bit sequences with the associated found contention-free states to form the contention-free structural test pattern.

15. The method of claim 14, further comprising:
simulating structural tests by applying the formed contention-free structural test pattern to the scan chain;
monitoring the outcome of the simulated tests using the logic simulator to locate any unidentified contending multiply driven nodes;
if the logic simulator cannot further locate any contending multiply driven nodes, then outputting the contention-free structural test pattern for testing the integrated circuit device for structural defects; and
if the logic simulator does locate contending multiply driven nodes, then repeating the above actions to replace the contention-causing bit sequences with contention-free states to form the contention-free structural test pattern.

16. The method of claim 15, wherein identifying multiply driven nodes having the potential for contention further comprises:
applying the predetermined number of random state assignments to test the device;
simulating and monitoring the test using the logic simulator;
monitoring during simulation to identify multiply driven nodes reaching a contention state; and
identifying the multiply driven nodes having the potential for contention based on the outcome of the monitoring.

17. The method of claim 16, wherein identifying one or more scan groups associated with each of the identified contention-causing multiply driven nodes further comprises:
performing a backward network traversal from each of the identified multiply driven nodes through combinational logic gates in an input cone and stopping when a scan element is found; and
grouping all the combinationally reachable scan elements in the input cone of the identified multiply driven nodes to form scan groups associated with each of the identified multiply driven nodes.

18. The method of claim 17, wherein creating independent scan groups further comprises:
identifying overlapping elements in each of the formed scan groups; and
merging the scan groups having overlapping elements using the identified overlapping elements to create independent scan groups.

19. The method of claim 18, wherein finding the contention-free states for each of the created independent scan groups further comprises:
if the number of scan elements in the identified independent scan groups is less than a predetermined number of scan elements, then applying and simulating all possible state assignments for the elements in the group, and further finding the contention-free states that do not result in contention at any of the multiply driven nodes driven by the independent scan groups; and
if the number of scan elements in the independent scan groups is greater than or equal to the predetermined number of scan elements, then applying and simulating the predetermined number of random state assignments for the created independent scan groups,
monitoring the simulation and finding states that do not result in contention at any of the multiply driven nodes driven by each of the independent scan groups.

20. A computer readable medium to store computer-executable instructions that are processed by a processor for performing a method for finding contention-free states in an integrated circuit device, comprising:
identifying multiply driven nodes having the potential for causing contention by applying a predetermined number of random state assignments to the integrated circuit device;
identifying a scan group associated with each of the identified contention-causing multiply driven nodes;
creating independent scan groups by identifying common elements in the identified scan groups and merging the identified scan groups to create independent scan groups; and
finding contention-free states for each of the created independent scan groups.

21. The computer readable medium of claim 20, further comprising:
applying structural test pattens to a scan chain in the integrated circuit using a logic simulator;
monitoring the outcome of the testing using the logic simulator to simulate and locate multiply driven nodes having contention;
mapping the multiply driven nodes having contention to the associated scan group to identify bit sequences in the structural test pattern that can cause contention; and
replacing the located contention-causing bit sequences with the associated found contention-free states to form the contention-free structural test pattern.

22. The computer readable medium of claim 21, further comprising:
simulating structural tests by applying the formed contention-free structural test patterns to the scan chain;
monitoring the outcome of the simulated tests using the logic simulator to locate any unidentified contending multiply driven nodes;
if the logic simulator cannot further locate any contending multiply driven nodes, then outputting the contention-free structural test pattern for testing the integrated circuit device for structural defects; and
if the logic simulator does locate contending multiply driven nodes, then repeating the above actions to replace the contention-causing bit sequences with contention-free states to form the contention-free structural test pattern.

23. The computer readable medium of claim 20, wherein identifying multiply driven nodes having potential for contention further comprises:
applying the predetermined number of random state assignments to test the device;
simulating and monitoring the test using a logic simulator;
monitoring during simulation to identify multiply driven nodes reaching contention state; and
identifying the multiply driven nodes having potential for contention based on the outcome of the monitoring.

24. The computer readable medium of claim 23 wherein identifying one or more scan groups associated with each of the identified contention-causing multiply driven nodes further comprises:
performing a backward network traversal from each of the identified multiply driven nodes through combinational logic gates in an input cone and stopping when a scan element is found; and
grouping all of the combinationally reachable scan elements in the input cone of the identified multiply driven nodes to form scan groups associated with each of the identified multiply driven nodes.

25. The computer readable medium of claim 24, wherein backward network traversal can be performed using algorithms selected from the group consisting of a standard acyclic graph traversal algorithm, a depth-first search algorithm, and a breadth-first search algorithm.

26. The computer readable medium of claim 25, wherein creating independent scan groups further comprises:
identifying overlapping elements in each of the formed scan groups; and
merging the scan groups having overlapping elements using the identified overlapping elements to create independent scan groups.

27. The computer readable medium of claim 26, wherein finding the contention-free states for each of the created independent scan groups further comprises:
if the number of scan elements in the identified independent scan groups has less than a predetermined number of scan elements, then applying and simulating all possible state assignments for the elements in the group, and further finding the contention-free states that do not result in contention at any of the multiply driven nodes driven by the independent scan groups; and
if the number of scan elements in the independent scan groups is greater than or equal to the predetermined number of scan elements, then applying and simulating the predetermined number of random state assignments for the created independent scan groups,
monitoring the simulation and finding states that do not result in contention at any of the multiply driven nodes driven by each of the independent scan groups.

28. The computer readable medium of claim 27, wherein simulating the predetermined number of random state assignments comprises:
stopping the simulation when a predetermined number of contention-free states are identified.

29. The computer readable medium of claim 28, wherein finding the contention-free states for each of the created independent scan groups comprises:
if the number of scan elements in the identified independent scan groups is greater than the predetermined number of scan elements, then simulating a functional sequence on a logic model of the design, monitoring states of the state elements comprising an independent scan group, and storing the combination of states as contention-free states.

30. The computer readable medium of claim 20, wherein replacing the located contention-causing multiply driven nodes in the random test pattern with the associated contention-free states further comprises:
replacing a first bit in the contention-free state with an unknown logic X;
re-simulating the replaced contention-free state to verify whether all of the multiply driven nodes driven by the independent scan groups remains contention-free:
randomly assigning the replaced first bit and leaving the first bit unspecified based on the outcome of the re-simulation; and
repeating the above actions to next subsequent bits in the contention-free state until all of the bit locations in the contention-free state have been verified to be necessary in the contention-free state.

31. A system for finding contention-free states in an integrated circuit device, comprising:
a processor;
a storage device to store instructions that are executable by the processor to perform a method, the method comprising:
identifying multiply driven nodes having the potential for causing contention by applying a predetermined number of random state assignments to the integrated circuit device;
identifying a scan group associated with each of the identified contention-causing multiply driven nodes;
creating independent scan groups by identifying common elements in the identified scan groups and merging the identified scan groups to create independent scan groups; and
finding contention-free states for each of the created independent scan groups.

32. The system of claim 31, wherein the method further comprises:
applying structural test patterns to a scan chain in the integrated circuit using a logic simulator;
monitoring the outcome of the testing using the logic simulator to simulate and locate multiply driven nodes having contention;
mapping the multiply driven nodes having contention to the associated scan group to identify bit sequences in the structural test pattern that can cause contention; and
replacing the located contention-causing bit sequences with the associated found contention-free states to form the contention-free structural test pattern.

33. The system of claim 32, wherein the method further comprises:
simulating structural tests by applying the formed contention-free structural test patterns to the scan chain;
monitoring the outcome of the simulated tests using the logic simulator to locate any unidentified contending multiply driven nodes;
if the logic simulator cannot further locate any contending multiply driven nodes, then outputting the contention-free structural test pattern for testing the integrated circuit device for structural defects; and
if the logic simulator does locate contending multiply driven nodes, then repeating the above actions to replace the contention-causing bit sequences with contention-free states to form the contention-free structural test pattern.

34. The system of claim 31, wherein identifying the multiply driven nodes having potential for contention further comprises:
applying the predetermined number of random state assignments to test the device;
simulating and monitoring the test using a logic simulator;
monitoring during simulation to identify multiply driven nodes reaching contention state; and
identifying the multiply driven nodes having potential for contention based on the outcome of the monitoring.

35. The system of claim 34, wherein identifying the one or more scan groups associated with each of the identified contention-causing multiply driven nodes further comprises:
performing a backward network traversal from each of the identified multiply driven nodes through combinational logic gates in an input cone and stopping when a scan element is found; and
grouping all of the combinationally reachable scan elements in the input cone of the identified multiply driven nodes to form scan groups associated with each of the identified multiply driven nodes.
